(19) United States
(12) Patent Application Publication
(10) Pub. No.: US 2009/0158286 A1
(43) Pub. Date: Jun. 18, 2009

(54) FACILITY FOR SCHEDULING THE EXECUTION OF JOBS BASED ON LOGIC PREDICATES

(75) Inventors: Francesco Maria Carteri, Rome (IT); Filomena Ferrara, Marino (IT); Scot MacLellan, Rome (IT)

Correspondence Address: IBM CORP. (AUSTIN), C/O NELSON AND NELSON, 2984 E. EVERGREEN AVE., SALT LAKE CITY, UT, 84109, US

(73) Assignee: INTERNATIONAL BUSINESS MACHINES CORPORATION, Armonk, NY (US)

(21) Appl. No.: 12/264,409

(22) Filed: Nov. 4, 2008

(30) Foreign Application Priority Data
Dec. 18, 2007 (EP) EP07301695

(51) Int. Cl. G06F 9/46

(52) U.S. Cl. 718/102

(57) ABSTRACT

A solution for scheduling execution of jobs in a data processing system is disclosed. One method for implementing such a solution may start by providing a scheduling structure for scheduling the execution of jobs. Such a scheduling structure may include a workflow plan defining a flow of execution for planned jobs and/or a workflow model defining static policies for execution of modeled jobs. A set of rules for updating the scheduling structure is provided. The method may continue by updating the scheduling structure according to the rules, such as by adding or removing jobs for rules evaluated to be true. The execution of the jobs may then be scheduled according to the updated scheduling structure. A corresponding system and computer program product are also disclosed.

### BACKGROUND

Workload schedulers (or simply schedulers) are commonly used to control the execution of large quantities of jobs in a data processing system. One example of a commercial scheduler is the “IBM Tivoli Workload Scheduler (TWS)” produced by IBM Corporation.

Typically, a scheduler controls the execution of jobs in a production period (such as one day) according to a workload plan (or simply “plan”). More specifically, the plan may specify the jobs that should be executed in the production period. The plan may also define a flow of execution for the jobs that satisfies predefined constraints.

For this purpose, all the jobs that are controlled by a scheduler may be defined in a workload model (or simply “model”). The model may define static policies for the execution of the jobs. More particularly, the model may set a run-cycle for each job (such as every day, week, or month). The model may also indicate temporal constraints that limit when the jobs can be executed. For example, it may be possible to specify an earliest time or a latest time of execution for a job or group of jobs, or a maximum allowable duration. The model may also indicate resource constraints that identify resources that are required for the execution of the jobs. For example, it may be possible to specify that the availability of specific information, software programs, or hardware devices is a prerequisite for the execution of jobs.

The model may also indicate dependency constraints, which define conditions that must be met before submitting jobs for execution. For example, it may be possible to specify that successor jobs can be submitted only after the successful completion of other predecessor jobs. The scheduler may access the model before every production period, in order to construct the plan accordingly. Particularly, the scheduler may add all the jobs to be executed in the production period to the plan (according to their run-cycles). The jobs may then be arranged in the plan so as to satisfy the corresponding temporal, resource and dependency constraints. In this way, it is possible to control the flow of execution of jobs on the basis of very sophisticated conditions. Moreover, the flow of execution can be optimized to reduce the execution time for the whole plan.

### SUMMARY

Embodiments of the invention relate to using rules for updating a scheduling structure.

One embodiment of the invention includes a method for scheduling the execution of jobs on a data processing system. The method may start by providing a scheduling structure for controlling the execution of jobs (such as a workflow plan defining a flow of execution of planned jobs and/or a workflow model defining static policies for execution of modeled jobs). A set of rules for updating the scheduling structure is also provided. The method may continue by updating the scheduling structure according to the rules, such as by adding or removing jobs in accordance with the rules. The execution of the jobs may then be scheduled according to the updated scheduling structure.

A corresponding system and computer program product for implementing the above-stated method is also disclosed and claimed herein.

### BRIEF DESCRIPTION OF THE DRAWINGS

In order that the advantages of the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 is a schematic block diagram of one embodiment of a data processing system for implementing a solution in accordance with the invention;

FIGS. 2 through 5 depict several examples of methods for implementing a solution in accordance with the invention;

FIG. 6 depicts another example of a method for implementing a solution in accordance with the invention; and

FIGS. 7A through 7B are collaboration diagrams representing the roles of various software components that may be used to implement a solution in accordance with the invention.

### DETAILED DESCRIPTION

It will be readily understood that the components of embodiments of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the disclosure, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that embodiments of the invention can be practiced without one or more of the specific details, or with other methods, components, etc. In other instances, well-known structures, or operations are not shown or described in detail to avoid obscuring aspects of the disclosure.

The illustrated embodiments of the invention will be best understood by reference to the drawings, wherein like parts are designated by like numerals throughout. The following description is intended only by way of example, and simply illustrates certain selected embodiments of the invention that are consistent with the disclosure as claimed herein.

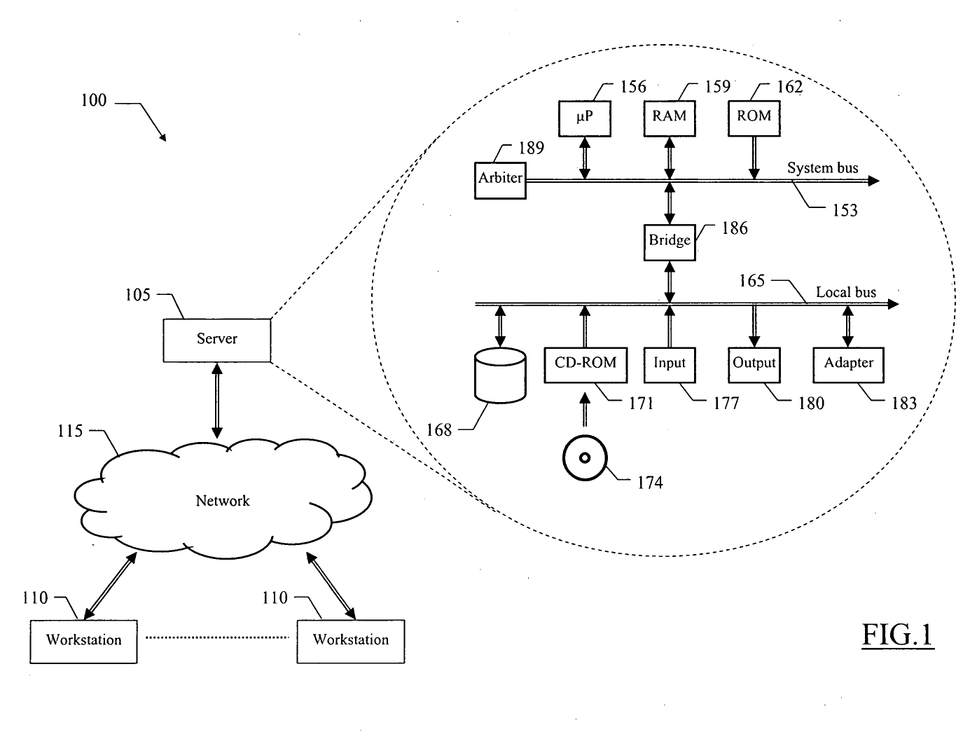

Referring to FIG. 1, one embodiment of a data processing system 100 with a distributed architecture is illustrated. The system 100 may include a scheduling server (or simply server) 105, which may be used to control the execution of jobs in the system 100. Typically, the jobs consist of batch (i.e., non-interactive) applications such as payroll or cost analysis programs. The jobs may be executed under the control of the server 105 on a plurality of target workstations (or simply workstations) 110. In certain embodiments, the server 105 and the workstations 110 communicate over a network 115, such as a LAN.

In selected embodiments, the server 105 may include several components connected in parallel to a system bus 153. For example, one or more microprocessors 156 may control the operation of the server 105. A RAM 159 may be used as a working memory by the microprocessors 156. A ROM 162 may store basic code to bootstrap the server 105. Various peripheral units may be clustered around a local bus 165 by means of respective interfaces. For example, mass memory may include one or more hard-disks 168 and drives 171 for reading storage media such as CD-ROMs 174. Moreover, the server 105 may include input units 177 (e.g., a keyboard, mouse, etc) and output units 180 (e.g., a monitor, printer, etc.). An adapter 183 may be used to connect the server 105 to the network 115. A bridge unit 186 may provide an interface between the system bus 153 and the local bus 165. Each microprocessor 156 and/or the bridge unit 186 may operate as master agents in requesting access to the system bus 153, in order to transmit information. An arbiter 189 may manage grants of access with mutual exclusion to the system bus 153.

The server 105 may control the execution of jobs on the workstations 110 according to a plan. This plan may define a flow of execution of jobs that are scheduled for execution in a corresponding production period. The plan may be created from a model, which defines static policies for execution of modeled jobs, from which the planned jobs may be extracted.

In a solution according to one embodiment of the invention, as described in detail hereafter, the model and/or plan (hereinafter generically denoted as “scheduling structure’ for the sake of simplicity) may be updated according to predefined rules. For example, updates may include adding or removing jobs as indicated in rules evaluated to be true. This solution may significantly simplify the management of the scheduling structure. Indeed, once the desired rules have been defined, the scheduling structure may be updated automatically without the need for manual operation. As a result, the process may be fast, simple, and robust. This advantage may be realized for massive updates, which can now be implemented with only one or more rules.

It should be emphasized that the rules may be applied to the model before the plan is constructed and/or at the time the plan is constructed, rather than when the jobs are actually submitted for execution. As a result, the plan may reflect the actual execution flow of the jobs (apart from unpredictable runtime problems). Therefore, the proposed solution does not affect the accuracy of the estimated execution time of the jobs. This limits the risk of any overrun of the plan, along with any corresponding deleterious effects for business activities depending on the execution of the jobs.

In one embodiment of the invention, updates of the scheduling structure are based on predicate logic, and more particularly on first-order logic. Predicate logic is a specific symbolic logic, and more specifically a formal system for specifying reasoning aimed at deriving the validity of propositions that express corresponding assertions. Predicate logic extends the propositional logic, which only considers a truth-value (i.e., true or false) for each proposition as a whole, with the possibility of considering the internal structure of the propositions. For this purpose, each proposition may be separated into predicates, subjects, and quantifiers. A predicate is an expression whose truth value depends on one or more subjects. The subjects are variables belonging to a predefined set. The quantifiers specify for which subjects the predicates are true.

For example, a universal quantifier (−) means for all the subjects, and an existential quantifier (½) means for at least one subject. Logic formulas can then be defined on the basis of the propositions. Particularly, atomic formulas consist of the truth value “true,” the truth value “false” and every predicate. Conversely, compound formulas are defined by two or more formulas that are combined with logic connectives. Examples of connectives include the implication (d), the equivalence (f), the negation (i), and the like.

Facts (consisting of propositions that are always true) can be proved from other facts. This is achieved by a logic inference process that starts from axioms, which are propositions that are taken to be true without any proof. The logic inference process deduces the new facts from the available facts by applying logic inference rules, which define how the available facts are to be combined to obtain the new facts. A typical example of an inference rule is the modus ponens:

(A AND AdB) d B

This rule means that if the proposition A (referred to as antecedent proposition) is true and the proposition A implies the proposition B, then the proposition B (referred to as consequent proposition) is also true.

The order of the logic is defined by the terms to which the quantifiers maybe applied. Particularly, in first-order logic, the quantifiers may be applied only to atomic formulas.

In one embodiment of the invention, applying (first-order) predicate logic to the scheduling of jobs is based on the definition of one or more (compound) formulas. Each formula has an antecedent proposition, which depends on the content of the scheduling structure (i.e., on the planned and/or modeled jobs). The formula also has a consequent proposition for controlling the execution of corresponding (inferred) jobs (i.e., jobs to be added to or removed from the scheduling structure). Each formula is evaluated by determining the truth value of the antecedent proposition, and then setting the consequent proposition to true when the antecedent proposition is true (according to the modus ponens). The scheduling structure is then updated according to the consequent propositions of the formulas that are true.

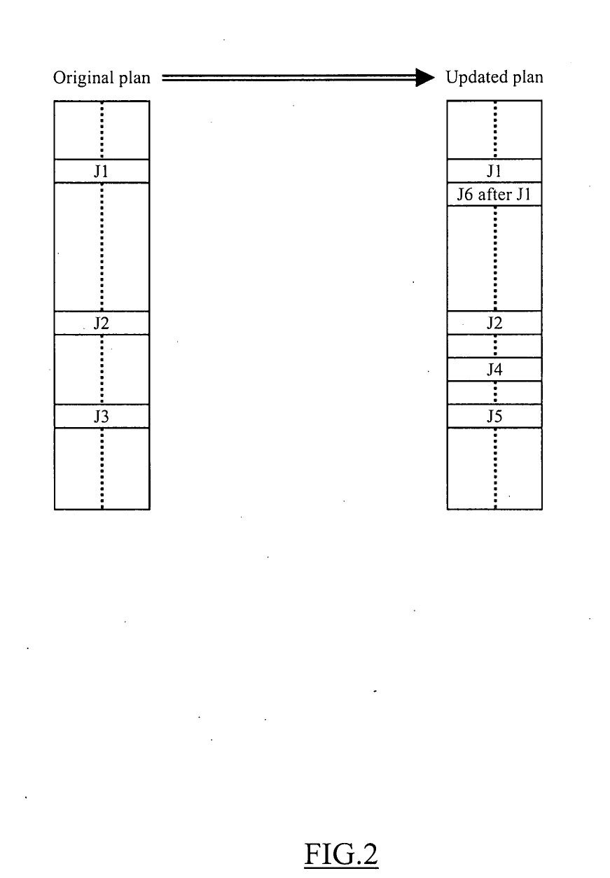

Different examples of applying the above-described solution to update the plan are illustrated in FIGS. 2 through 5, with reference to some very simplified scenarios. This feature may be advantageously exploited to apply changes for a temporary period only (without having to act on the model). Moreover, the same feature may also be used to test the changes before applying them permanently to the model.

Referring to FIG. 2, an original plan has been constructed according to the run cycles of jobs. In particular, the original plan includes the jobs J1, J2, and J3. Assume that the following formulas have been defined:

P(J1 AND J2) d P(J4, J5),

P(J1) d P(J6 after J1),

P(J7) d P(J8), and

P(J2) d NOT P(J3),

These formulas mean that when both jobs J1 and J2 have been scheduled, jobs J4 and J5 need to be added to the plan; when job J1 has been scheduled, job J6 needs to be added to the plan as a successor of job J1; when job J7 has been scheduled, job J8 needs to be added to the plan; and when job J2 has been scheduled, job J3 needs to be removed from the plan.

The evaluation of these formulas (according to the current content of the plan) determines that the formulas P(J1 AND J2) d P(J4, J5),P(J1) d P(J6 after J1), and P(J2) d NOT P(J3) are true, while the formula P(J7) d P(J8) is false. Therefore, the plan is updated so as to obtain a corresponding updated plan, wherein the jobs J4, J5, J6 (as a successor of the job J1) are added, and the job J3 is removed.

The above-mentioned formulas may be used to add or remove jobs that are dynamically dependent on other jobs from the plan. For example, formulas may be used to specify that when a job for executing a script and a job for collecting an output of the script are scheduled, a job for parsing the output and a job for inserting the output into a database are to be added to the plan (with the correct dependency constraints). As another example, formulas may be used to specify that when a job for migrating a database is scheduled, a job for performing transactions on the database should be removed from the plan.

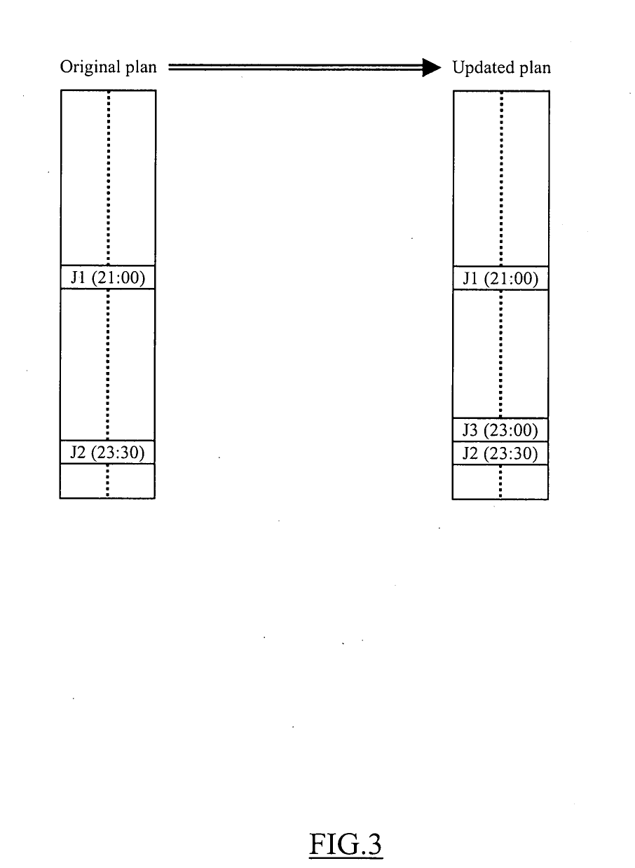

Referring now to FIG. 3, an original plan may include a job J1 scheduled for execution at 21:00, and a job J2 scheduled for execution at 23:30. Assume now that the following parametric formulas have been defined:

P(J1 between 20:00 and 22:00) d P(J3 at 23:00), and

P(J2 between 15:00 and 16:00) d NOT P(J4),

These formulas mean that when job J1 has been scheduled for execution between 20:00 and 22:00, job J3 needs to be added to the plan for execution at 23:00, and when job J2 has been scheduled for execution between 15:00 and 16:00, job J4 needs to be removed from the plan.

The evaluation of these formulas according to the current content of the plan determines that the formula P(J1 between 20:00 and 22:00) d P(J3) is true, while the formula P(J2 between 15:00 and 16:00) d NOT P(J4) is false. Therefore, the plan is updated to obtain a plan with job J3 added for execution at 23:00.

The above-mentioned formulas may be used to add or remove jobs from the plan based on the fulfillment of specific conditions for other jobs. For example, the formulas may specify that when a job for executing a backup of a database is scheduled at night, a job for stopping a corresponding database server and a job for exporting the information on the database server are to be added to the plan beforehand, and a job for cleaning-up historical information on the database server and a job for restarting the database server are to be added to the plan afterwards.

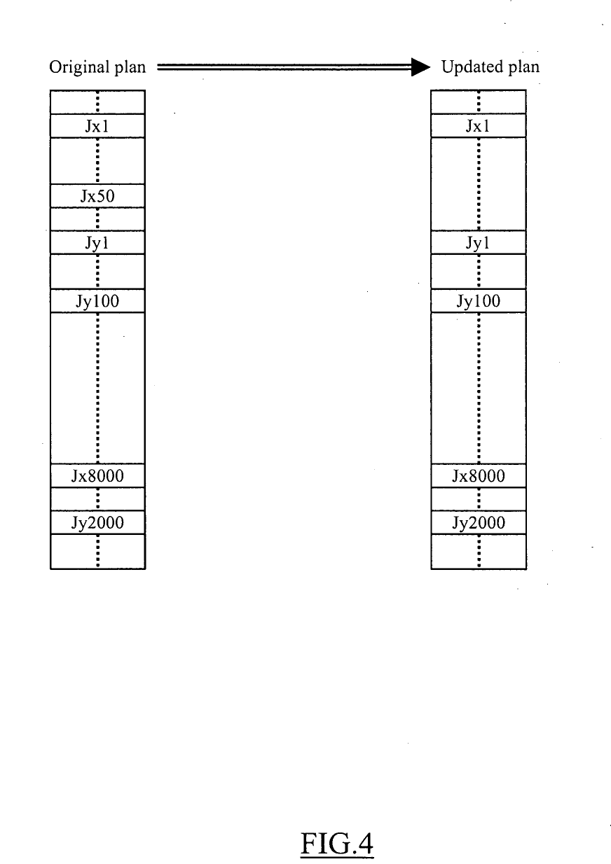

Another example is shown in FIG. 4, where an original plan includes 8000 jobs Jxi (wherein i=1 . . . 8000) scheduled for execution on a workstation “X”, and 2000 jobs Jyj (wherein j=1 . . . 2000) scheduled for execution on a workstation “Y”. Assume that the following quantitative formulas have been defined:

P(>5000 jobs on X) d NOT P(Jx50), and

P(>5000 on Y) d NOT P(Jy100)

These formulas mean that when the number of jobs that have been scheduled for execution on workstation “X” exceeds 5000, job Jx50 needs to be removed from the plan, and when the number of jobs that have been scheduled for execution on workstation “Y” exceeds 5000, job Jy100 should be removed from the plan.

The evaluation of these formulas in the illustrated plan determines that the formula P(>5000 jobs on X) d NOT P(Jx50) is true, while the formula P(>5000 on Y) d NOT P(Jy100) is false. Therefore, the plan is updated to obtain a plan with job Jx50 removed.

The above-mentioned formulas may be used to add or remove jobs that are dynamically dependent on the fulfillment of quantitative conditions for the plan. For example, the formulas may be used to specify that when a certain number of jobs are scheduled for execution, less critical jobs may be removed from the plan. This feature may be used to provide an acceptable degree of performance.

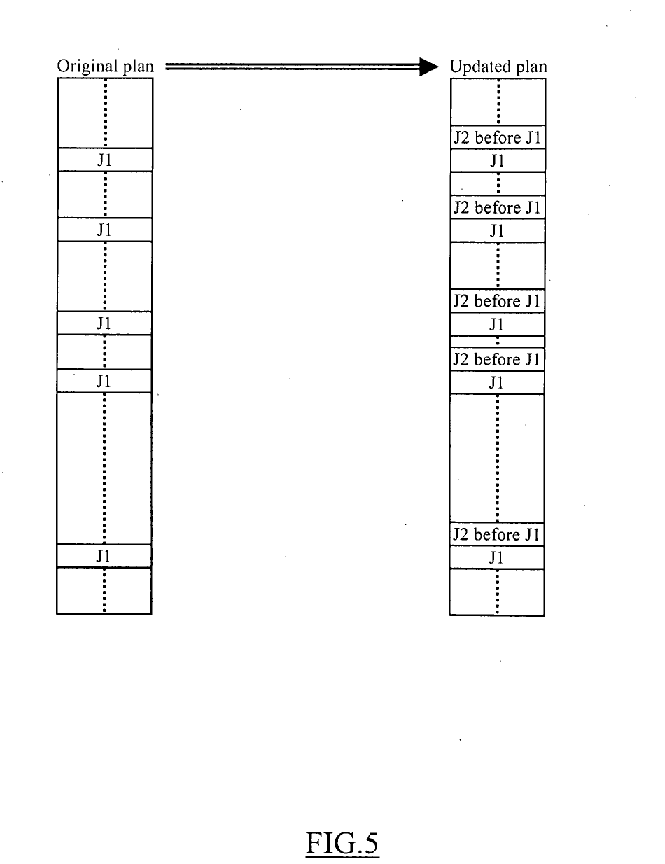

Referring now to FIG. 5, an original plan may include several instances of execution of the same job J1 at different times and/or on different workstations (five in the illustrated scenario). Assume that the following formulas have been defined:

P(J1) d P(J2 before J1, −J1), and

P(J3) d P(J4 before J3, −J3)

These formulas mean that when job J1 has been scheduled for execution, job J2 needs to be added to the plan as a predecessor of each instance of job J1, and when job J3 has been scheduled for execution, job J4 needs to be added to the plan as a predecessor of each instance of job J3.

The evaluation of these formulas (according to the illustrated content of the plan) determines that the formula P(J1) d P(J2 before J1, −J1) is true, while the formula P(J3) d P(J4 before J3, −J3) is false. Therefore, the plan may be updated to obtain a plan wherein job J2 is added as a predecessor for each instance of job J1 (five times in the illustrated example).

The above-mentioned formulas may be used to add or remove jobs that are dynamically dependent on multiple instances of other jobs. For example, formulas may specify that whenever a job for updating a database is scheduled, a job for backing up the database should be added beforehand. It should be noted that the desired result may be achieved with a single formula regardless of the number of instances of a job in the original plan.

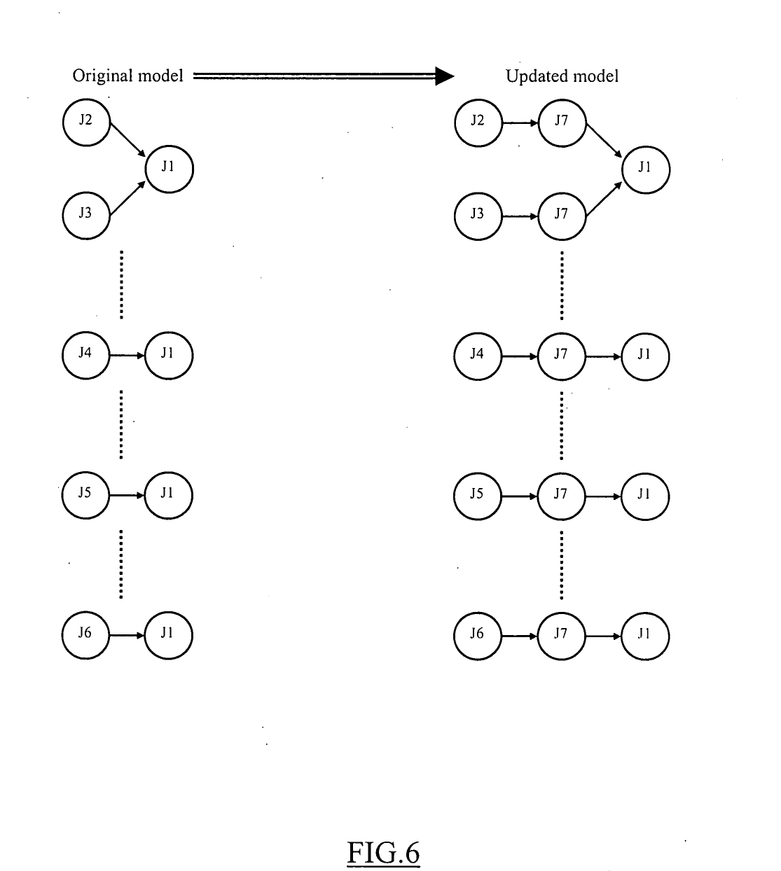

An example of applying the above-described solution is illustrated in FIG. 6. This feature may be advantageously exploited to maintain an updated scheduling environment in response to continually evolving requirements.

For example, an original model may include several occurrences of the same job J1. For example, job J1 may be shown as a successor for various different jobs (such as jobs J2 and J3, job J4, job J5, and job J6, as illustrated). Each dependency constraint may be represented by an arrow from the corresponding predecessor job (i.e., J2, J3, J4, J5 and J6) to the successor job J1. Assume now that the following formula has been defined:

P(J1) d P(J7 before J1, −J1),

This formula means that when job J1 is included in the model, job J7 has to be added to the model as a predecessor for each instance of job J1.

The evaluation of this formula (according to the illustrated model) determines that the formula is true. Therefore, the model may be updated to obtain a model with job J7 added as a predecessor for each occurrence of job J1 (four in the illustrated example). Thus, any dependency constraint having job J1 as a successor is opened. Job J7 is inserted as a successor of jobs that were predecessors to job J1, and as a predecessor of job J1 in order to close the dependency constraint correctly.

These formulas may be used to add or remove multiple instances of jobs from the model using a single formula, irrespective of the number of occurrences of jobs. At the same time, these formulas may enable updating any constraints automatically. Similar considerations may apply to the use of the preexistence formulas, parametric formulas, and/or quantitative formulas described above.

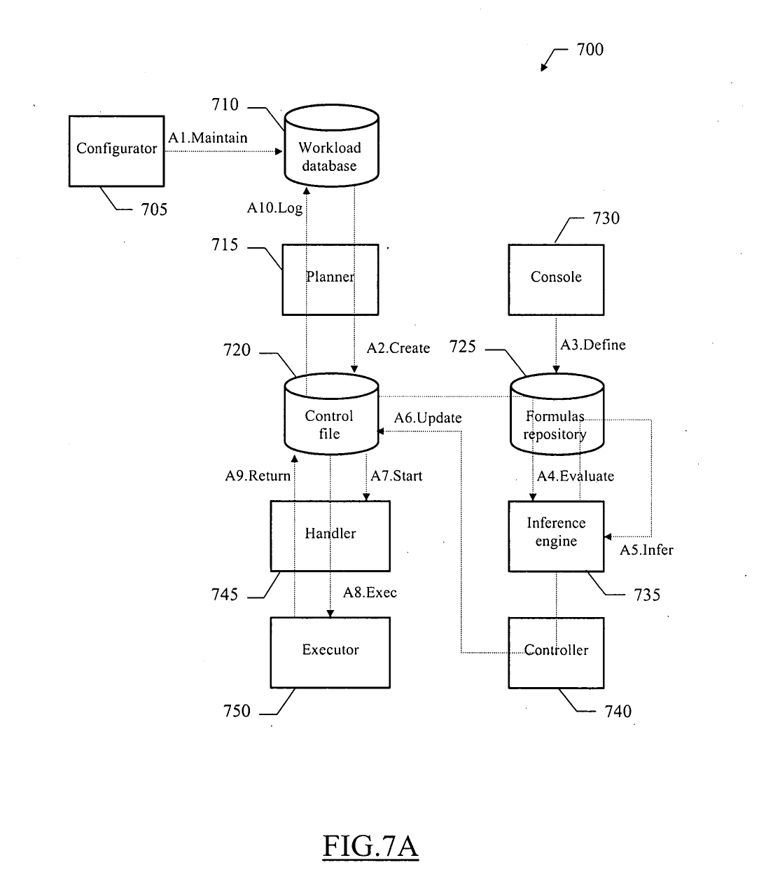

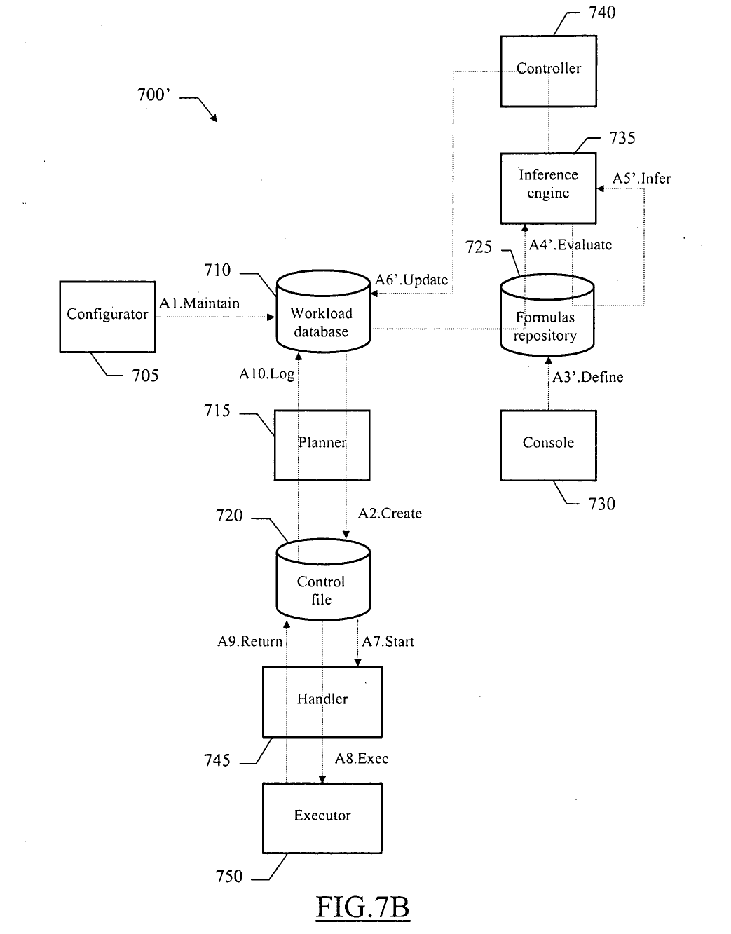

Referring to FIG. 7A, various software components that may be used to implement a method in accordance with the invention are denoted as reference number 700. These software components may be stored on a hard-disk and may be loaded in whole or in part into the working memory of a server, together with an operating system and other application programs (not shown). The software components may be initially installed onto a hard disk from, for example, a CD-ROM. FIG. 7A describes the static structure of the system (by means of the corresponding components) and its dynamic behavior (by means of a series of exchanged messages, each one representing a corresponding action, denoted with sequence numbers preceded by the symbol “A”).

In certain embodiments, a scheduler 700 (such as the above-mentioned “TWS”) runs on a server. The scheduler 700 may include a configurator 705 (such as the “Composer” of “TWS”) which is used to maintain a workload database 710 written in a suitable control language (e.g., XML-based action “A1.Maintain”). The workload database 710 may contain a definition of all workstations which are available to the scheduler 700.

For example, each workstation may be defined by information (such as a host name, IP address, or the like) required to access the workstation, together with its physical/logical characteristics (such as processing power, memory size, operating system, or the like). The workload database 710 may also include a descriptor for each job. The job descriptor may specify the programs to be invoked (with their arguments and environmental variables). The job descriptor may also define a static policy for execution of the job. In particular, the policy may indicate the workstations on which the job may be executed, either by their names or by their characteristics (so that they can be selected at runtime). The policy may also provide the run-cycle of the job (defining when it should be executed).

Optionally, the policy may specify constraints for execution of a job. In particular, temporal constraints may limit when the job can be executed, resource constraints may identify resources that are required for execution of the job (such as specific software programs), and dependency constraints may indicate conditions that should be met before the job can be submitted for execution (such as completion of other jobs). The jobs may be organized into streams, with each stream including an ordered sequence of logically related jobs which should be executed as a single work unit (respecting possible constraints). For the sake of simplicity, the term “job” will be used hereinafter to denote either a single job or a job stream. The workload database 710 may also store statistic information relating to previous executions of jobs (such as logs of the jobs' duration from which a corresponding next duration may be estimated). For example, the workload database 710 may be maintained by application developers (which define jobs) and by a system administrator (which defines policies for their execution).

A planner 715 (such as the “Master Domain Manager” of the “TWS”) may be used to create a basic version of the plan, whose definition is stored in a control file 720 (such as the “Symphony” of the “TWS” (action “A2.Create”)). The plan may specify the flow of execution of a batch of jobs in the corresponding production period, together with the definition of the required workstations. A new plan may be created automatically before every production period. For this purpose, the planner 715 may process the information available in the workload database 710 in order to select the jobs to be executed (according to their run-cycles) and to arrange them in a desired sequence (according to their expected duration and constraints). The planner 715 may create the plan by adding jobs to be executed in the next production period, and by removing jobs of the previous production period that have been completed. In addition, the jobs of the previous production period that did not complete successfully or that are still running or waiting to be executed may be maintained in the plan (for execution during the next production period).

In a solution according to one embodiment of the invention, a repository 725 may store formulas for updating the plan dynamically. A console 730 may be used to add, delete, and edit the formulas in the repository 725 (action “A3.Define”). An inference engine 735 may access the control file 720 and the repository 725 in order to evaluate all the predicates of the formulas (in the repository 725) according to the current state of the plan in the control file 720 (action “A4.Evaluate”). The inference engine 735 may then evaluate the compound formulas (in the repository 725) by applying the inference rules embedded in its definition (action “A5.Infer”). Preferably, the inference engine 735 is provided with specific plug-ins for the different types of compound formulas to be evaluated (for example, by applying logical reasoning, implementing custom algorithms, and/or reading statistic information of the jobs). A controller 740 may update the plan in the control file 720 according to the formulas that have been evaluated as true (action “A6.Update”).

A handler 745 (such as the “Batchman” process of the “TWS”) may extract the plan from the control file 720 and initiate it at the beginning of the production period (action “A7.Start”). The handler 745 may submit each planned job for execution as soon as possible. For this purpose, the handler 745 may select an available workstation having the required characteristics (typically, according to information provided by a load balancer).

The actual execution of the jobs may be managed by a corresponding module 750 (such as the “Jobman” process of the “TWS” (action “A8.Exec”)). For this purpose, the executor 750 may interface with an agent running on each workstation. The agent may enforce the execution of each job in response to a corresponding command received from the executor 750, and may return feedback information relating to the result of its execution. This feedback may include, for example, whether the job has been completed successfully, its actual duration, and the like. The feedback information for all the executed jobs may be passed by the executor 750 to the handler 745, which may enter it into the control file 720 (action “A9.Return”). This provides a real-time picture of the current state of all the jobs of the plan. At the end of the production period, the planner 715 may access the control file 720 to update the statistical information in the workload database 710 relating to the executed jobs (action “A10.Log”).

Referring now to FIG. 7B, various software components that may be used to implement another embodiment of a method in accordance with the invention are denoted as reference number 700′. In the following description, elements similar to those shown in FIG. 7A are denoted with the same reference numbers, and their explanation may be omitted for the sake of simplicity.

In this example, a repository 725 may store formulas for updating the model. A console 730 may be used to define the formulas in the repository 725 (action “A3′.Define”). An inference engine 735 may access a workload database 710 and the repository 725 in order to evaluate all the predicates of the formulas (in the repository 725) according to the current state of the model in the workload database 710 (action “A4′ Evaluate”). The inference engine 735 may then evaluate the compound formulas in the repository 725 by applying the inference rules embedded in its definition (action “A5′.Infer”). A controller 740 may update the model in the workload database 710 according to formulas that have been evaluated as true (action “A6′.Update”). A planner 715 may create the plan according to the content of the workload database 710 (action “A2.Create”). The execution of the plan may then be controlled as described above (actions “A7-A10”).

Naturally, in order to satisfy local and specific requirements, a person skilled in the art may logically and/or physically modify the solution described above. Thus, although embodiments of the invention have been described with a certain degree of particularity with reference to various embodiments, it should be understood that various omissions, substitutions, and changes in form and detail are possible. The proposed solution may even be practiced without specific details (such as the numerical examples) set forth in the preceding description. Furthermore, well-known features may have been omitted or simplified in order to not obscure the description with unnecessary particulars. Moreover, it is intended that specific elements and/or method steps described in connection with any of the disclosed embodiment of the invention may be incorporated into any other embodiment as a matter of general design choice.

The proposed solution may be implemented with an equivalent method (by using similar steps, removing some non-essential steps, or adding optional steps). Moreover, the steps may be performed in a different order, concurrently, or in an interleaved manner.

Even though the preceding description makes reference to jobs as part of batch applications, this is not intended as a limitation. Indeed, the same solution may be used to schedule the execution of interactive tasks, or more generally jobs consisting of different work units.

Moreover, the same solution may be used to update a plan or to update a model (as described above), to update both a plan and a model at the same time, or more generally to update any other scheduling structure that is adapted to control the scheduling of jobs in the broadest meaning of the term.

Alternatively, the basic version of the plan (to which the formulas are applied) may be created in different ways. For example, it is possible to set more sophisticated run-cycles for jobs (such as every day with the exception of weekends). Likewise, it is possible to specify different constraints (such as enabling constraints based on an operator entering a response to a prompt). Moreover, the model may provide equivalent policies of execution for jobs, for example, by selecting corresponding workstations according to statistical methods aimed at distributing the execution of jobs uniformly throughout the system.

The proposed solution may also be implemented by deducting the true propositions used for controlling the execution of the inferred jobs with more complex reasoning (i.e., based on a chain of formulas that are proved starting from the logic predicates depending on the planned and/or modeled jobs). For this purpose, it is possible to apply any other inference rules (for example, reductio ad absurdum, double negative elimination, and the like). Moreover, the formulas may be defined with any other quantifiers and/or connectives.

Alternatively, the use of higher-order logic (such as a second-order logic wherein the quantifiers may be applied to compound formulas as well) is within the scope of the proposed solution. Moreover, nothing prevents exploiting other formal logic, such as propositional logic, modal logic, or the like).

More generally, it is possible to provide any other type of rules that define conclusions for controlling execution of one or more inferred jobs (either already included in the scheduling structure or not). The rules depend on dynamic conditions, which are based on the planned and/or modeled jobs. The rules are resolved (by exploiting any suitable deduction method) to assert the conclusions according to the evaluation of the dynamic conditions (as defined by the actual state of the scheduling structure, possibly taking into account the updates involved by the rules themselves). The asserted conclusions (i.e., the conclusions that are true in a specific situation) are then used to update the scheduling structure accordingly.

The above-described examples of applications of the proposed solution are merely illustrative, and thus should not be interpreted as limiting.

For example, it is possible to have preexistence formulas with predicates based on other characteristics of the scheduling structure as defined by the planned and/or modeled jobs (such as a distribution pattern of jobs on different workstations).

Moreover, nothing prevents defining other conditions in parametric formulas (such as based on the scheduled duration of jobs, on the workstations where they are intended to be executed, and so forth).

Likewise, different quantitative formulas may be defined (such as based on the total number of planned jobs).

Alternatively, it is possible to have formulas that only add jobs to the scheduling structure, that only remove planned and/or modeled jobs, or a combination thereof.

As a further improvement, it is also possible to define predicates that depend on categories of jobs having specific characteristics. Formulas based on these predicates can then be used to control the execution of inferred jobs for all the jobs in these categories. For example, a formula:

P(−J1, J1 accesses DB1) d P(J2 before J1)

may be defined to add the job J2 to the scheduling structure as a successor of every planned and/or modeled job J1 accessing the database DB1 (without the need to specify in the formula the jobs that actually perform this operation). When the formula is evaluated, the inference engine may determine the planned and/or modeled jobs J1 that access the database DB1 (as indicated by their descriptors), and then add the predecessor job J2 before them.

The formulas may also be used to update any other dependency constraints, or more generally whatever types of constraints exist in the scheduling structure (such as temporal constraints, resource constraints, dependency constraints, or any combinations thereof). Moreover, the same formulas may simply add or remove constraints for jobs already included in the scheduling structure.

The proposed solution may be applied to any workload scheduler or equivalent application. In any case, it may be implemented as a stand-alone module, as a plug-in for the workload scheduler, or even directly embedded in the workload scheduler. It is also possible to deploy the same solution as a service accessed through a network (such as the Internet). Similar considerations apply if a program (which may be used to implement embodiments of the invention) is structured in a different way, or if additional modules or functions are provided. Likewise, the memory structures may be of other types, or may be replaced with equivalent entities (not necessarily consisting of physical storage media). In any case, the program may take any form suitable to be used by any data processing system or in connection therewith (for example, within a virtual machine). Particularly, the program may be in the form of external or resident software, firmware, or microcode (either in object code or in source code, for example, to be compiled or interpreted). Moreover, it is possible to provide the program on any computer-usable medium. The medium may be any element suitable to contain, store, communicate, propagate, or transfer the program. For example, the medium may be of the electronic, magnetic, optical, electromagnetic, infrared, or semiconductor type. Examples of such a medium are fixed disks (where the program can be pre-loaded), removable disks, tapes, cards, wires, fibers, wireless connections, networks, broadcast waves, and the like. In any case, the solution also lends itself to being implemented with a hardware structure (for example, integrated in a chip of semiconductor material), or with a combination of software and hardware.

The proposed method may be carried out on a system having a different architecture or including equivalent units (for example, based on a global network). However, implementation on a stand-alone computer is not excluded. Moreover, the server may include similar elements (such as cache memories temporarily storing the programs or parts thereof). In any case, it is possible to replace the server with any code execution entity (such as a PDA, a mobile phone, or the like), or with a combination of code execution entities (such as a multi-tier architecture, a grid computing infrastructure, or the like).

1. A method for scheduling the execution of jobs in a data processing system, the method comprising:
providing a scheduling structure for scheduling the execution of jobs;
providing a set of rules for updating the scheduling structure;
updating the scheduling structure according to the rules; and
scheduling the execution of the jobs according to the updated scheduling structure.

2. The method of claim 1, wherein:
the scheduling structure includes a workload plan defining a flow of execution for a set of planned jobs; and
scheduling the execution of the jobs includes submitting planned jobs for execution according to an updated workload plan.

3. The method of claim 1, wherein:
the scheduling structure includes a workload model defining static policies for executing a set of modeled jobs; and
scheduling the execution of the jobs includes creating a workload plan defining a flow of execution for a set of planned jobs according to an updated workload model, and submitting the planned jobs for execution according to the workload plan.

4. The method of claim 2, wherein:
the rules define conclusions depending on dynamic conditions based on the planned jobs; and
updating the scheduling structure includes resolving the rules to assert the conclusions according to an evaluation of the dynamic conditions, and updating the scheduling structure according to the asserted conclusions.

5. The method of claim 4, wherein:
providing a set of rules includes providing a set of atomic logic formulas, each atomic logic formula comprising a logic predicate of the planned jobs, and providing a set of compound logic formulas, each compound logic formula comprising a plurality of logic formulas combined with logic connectives; and
resolving the rules includes evaluating a truth-value of the logic predicate of each atomic logic formula, the truth-value being one of true and false, and evaluating the truth-value of each compound logic formula by applying predefined inference rules.

6. The method of claim 5, wherein:
at least one compound logic formula includes an antecedent proposition implying a consequent proposition;
resolving the rules includes determining a truth-value of the antecedent proposition, and setting the consequent proposition to true in response to the antecedent proposition being true; and
updating the scheduling structure includes updating the scheduling structure according to the consequent proposition in response to the consequent proposition being true.

7. The method of claim 6, wherein:
at least one compound logic formula includes an antecedent proposition based on a set of preexistence jobs; and
determining the truth-value of the antecedent proposition includes verifying that the preexistence jobs are included in the scheduling structure.

8. The method of claim 7, wherein:
at least one compound logic formula includes an antecedent proposition based on a set of preexistence conditions for the preexistence jobs; and
determining the truth-value of the antecedent proposition includes verifying fulfillment of the preexistence conditions by the preexistence jobs included in the scheduling structure.

9. The method of claim 8, wherein:
at least one compound logic formula includes an antecedent proposition based on a set of quantitative conditions for the scheduling structure; and
determining the truth-value of the antecedent proposition includes verifying fulfillment of the quantitative conditions by the planned jobs.

10. The method of claim 9, wherein:
at least one compound logic formula includes a consequent proposition including an indication of a set of inclusion inferred jobs; and
updating the scheduling structure includes adding the inclusion inferred jobs to the scheduling structure in response to the conclusion proposition being evaluated as true.

11. The method of claim 10, wherein:
at least one compound logic formula includes a consequent proposition including an indication of a set of exclusion inferred jobs; and
updating the scheduling structure includes removing the exclusion inferred jobs from the scheduling structure in response to a conclusion proposition being evaluated as true.

12. The method of claim 11, wherein:
the scheduling structure includes constraints of execution for a set of constrained jobs; and
updating the scheduling structure includes updating the constraints according to one of: addition of the inclusion inferred jobs and removal of the exclusion inferred jobs.

13. A computer program product for scheduling the execution of jobs in a data processing system, the computer program product comprising a computer-usable medium having computer-usable program code embodied therein, the computer-usable program code comprising:
computer-usable program code for providing a scheduling structure for scheduling the execution of jobs;
computer-usable program code for providing a set of rules for updating the scheduling structure;
computer-usable program code for updating the scheduling structure according to the rules; and
computer-usable program code for scheduling the execution of the jobs according to the updated scheduling structure.

14. The computer program product of claim 13, wherein:
the scheduling structure includes a workload plan defining a flow of execution for a set of planned jobs; and
scheduling the execution of the jobs includes submitting planned jobs for execution according to an updated workload plan.

15. The computer program product of claim 13, wherein:
the scheduling structure includes a workload model defining static policies for executing a set of modeled jobs; and
scheduling the execution of the jobs includes creating a workload plan defining a flow of execution for a set of planned jobs according to an updated workload model, and submitting the planned jobs for execution according to the workload plan.

16. A system for scheduling the execution of jobs in a data processing system, the system comprising:
a planner to generate a scheduling structure for scheduling the execution of jobs;
a repository for storing a set of rules for updating the scheduling structure;
a controller for updating the scheduling structure according to the rules; and
a handler to execute the jobs according to the updated scheduling structure.
